(19) United States
(12) Patent Application Publication
(10) Pub. No.: US 2005/0057054 A1
(43) Pub. Date: Mar. 17, 2005

(54) Pet bandana and sanitary device

(76) Inventor: Kenneth Carrol Hopkins, Ft Collins, CO (US)

Correspondence Address: Barber Legal, PO Box 16220, Golden, CO, 80402-6004, US

(21) Appl. No.: 10/973,873

(22) Filed: Oct. 25, 2004

Related U.S. Application Data
(63) Continuation-in-part of application No. 10/345,298, filed on Jan. 15, 2003.
(60) Provisional application No. 60/349,452, filed on Jan. 18, 2002.

(51) Int. Cl. A01K 29/00

(52) U.S. Cl. 294/1.3

(57) ABSTRACT

A sanitary pet waste disposal device of flexible polymer is both a bag and also a bandana. The substantially flat body of the bag has a planform/shape and two layers. The shape may be in a right triangle and the layers may be printed with a bandana pattern thereon. In use the device is first worn by a pet around the neck as a bandana, then removed as needed and used as a plastic bag to dispose of pet fecal matter. The device may also have stiffeners located along the edges near the opening of the bag to allow easier use of the bag.

### CROSS-REFERENCE TO RELATED APPLICATIONS

This application is a continuation-in-part division of and claims the benefit and filing date of parent application Ser. No. 10/345,298 filed in the United States Patent and Trademark Office on Jan. 15, 2003, with the title BANDANA DOGGIE POOH BAG in the name of the same inventor, Kenneth C. Hopkins, for which the entire disclosure is incorporated by reference, and through that application further claim the benefit of provisional application No. 60/349,452 filed in the United States Patent and Trademark Office on Jan. 18, 2002 with the title BANDANA DOGGIE POOH BAG and with the same inventor, Kenneth C. Hopkins.

### FIELD OF THE INVENTION

This invention relates generally to sanitary devices for pet waste disposal and specifically to a sanitary device carried by the pet.

### STATEMENT REGARDING FEDERALLY FUNDED RESEARCH

This invention was not made under contract with an agency of the US Government, nor by any agency of the US Government.

### BACKGROUND OF THE INVENTION

Pet owners put considerable effort into disposing of the wastes of their pets, a task considered unpleasant. As a result, a great deal of ingenuity has been spent on finding better and better solutions to this problem.

One broad family of solutions consists of the “plastic bag” family. These devices use disposable poly-bags to allow convenient, sanitary handling and disposal of pet wastes. The user takes a poly-bag and opens it, and may partially invert the interior of the bag out of the mouth of the bag. Handling is done on the outsides of the bag. Some individuals use the inverted bag as an entire plastic glove. The inverted bag is then placed over the waste to be disposed of and while continuing to handle the outside of the bag, the interior is used to handle and contain the waste, and the bag may be picked up by the outside with the pet waste sanitarily contained on the inside. While the structure of the present invention is unique, the method outlined here, used with conventionally shaped bags, is widely used by pet owners around the world.

One type of solution to this problem comprises pet wear which contains the gear necessary for the sanitary disposal of pet wastes. The common type of arrangement is a small cylinder carried by the pet on the leash or collar. The cylinder is a dispenser for a plurality of plastic bags held therein, the plastic bags are used to remove and then dispose of pet wastes.

Unrelated to pet waste issues, it is known that pets may wear clothing in order to increase their charisma and enhance their image. One common type of pet clothing is the bandana, a generally square shape folded into a right triangle, or simply a right triangle in shape, which is tied around the pet's neck.

### SUMMARY OF THE INVENTION

General Summary

The present invention is sanitary pet waste disposal device of flexible polymer which is both a bag and yet also a bandana. The substantially flat body of the bag has a planform/shape and two layers: the shape may be in a right triangle and the layers may be printed with a bandana pattern thereon. In use the device is first worn by a pet around the neck as a bandana, then removed by the owner as needed and used as a plastic bag to dispose of pet fecal matter. The device may also have stiffeners located along the edges near the opening of the bag to allow easier use of the bag.

Bandana patterns as disclosed herein include “western” designs, maps, logos, paisley designs, and so on, as well as colors, shapes, and images.

The polymer of choice may be any polymer suitable for the intended use by being flexible, low cost, easy to produce, easy to print upon and may be textured for additional esthetic appeal or ease of handling.

Summary in Reference to Claims

It is thus a first aspect, advantage, objective and embodiment to provide a pet waste disposal device comprising: a substantially flat body having a planform and edges; the body comprising a first layer and a second layer each having a first edge portion and a second edge portion, the first and second layer having substantially the same planform as the body, the first and second layers being joined at their respective first edge portions, and forming a hole therebetween at the respective second edge portions, the first and second layer comprising a flexible polymer material; a printed pattern on at least one of the first and second layer.

It is thus another aspect, advantage, objective and embodiment to provide a pet waste disposal device wherein the printed pattern further comprises: a bandana print pattern.

It is thus another aspect, advantage, objective and embodiment to provide a pet waste disposal device wherein the planform of the first and second layers and body is a right triangle having two right edges and one hypotenuse edge and having two elongated points formed by the non-right angles of the right triangle.

It is thus another aspect, advantage, objective and embodiment to provide a pet waste disposal device wherein the second edge portion is located on the hypotenuse edge of the right triangular body.

It is thus another aspect, advantage, objective and embodiment to provide a pet waste disposal device wherein the second edge portion is located at one angle of the right triangular body.

It is thus another aspect, advantage, objective and embodiment to provide a pet waste disposal device wherein the second edge portion is located at one non-hypotenuse edge of the right triangular body.

It is thus another aspect, advantage, objective and embodiment to provide a pet waste disposal device wherein the planform of the first and second layers and body is a prism.

It is thus another aspect, advantage, objective and embodiment to provide a pet waste disposal device further comprising: at least one stiffener located at the first edge portion adjacent to the second edge portion.

### BRIEF DESCRIPTION OF THE DRAWINGS

FIG. 1 is a planform top view of a first embodiment of the invention.

FIG. 2 is a front view of the first embodiment of the invention, with the opening therein partially opened.

FIG. 3 is a planform top view of a second embodiment of the invention.

FIG. 4 is a planform top view a third embodiment of the invention.

FIG. 5 is a perspective view of a fourth embodiment of the invention, folded for wearing by a dog.

FIG. 6 is a side view of a large pet wearing the invention.

FIG. 7 is a planform top view of a fifth embodiment of the invention.

FIG. 8 is a top view of a sixth embodiment of the invention.

FIG. 9 is a side view of a large pet wearing the invention in a more popular fashion.

### INDEX TO REFERENCE NUMERALS

10 Top Layer/Front Side

12 Body

14 Printed Side

20 Bottom Layer/Rear Side

30 Open Portion/Opening

40 Sealed Portion/Seal

50 Stiffening Tabs

50′ Stiffening Tabs

52 Sealed Portion/Seal

54 Sealed Portion/Seal

56 Open Portion

58 Open Portion

60 Body

62 Interior of Bag

64 Sealed Portion/Seal

70 Body

72 Printed Pattern

100 Large Pet

102 Invention

104 Knot

### DETAILED DESCRIPTION

FIG. 1 is a planform top view of a first embodiment of the invention. The body 12 of the device may be considered to be either a pet bandana or a polymer bag such as plastic. Top layer (also front side) 10 and bottom layer (also rear side) 20 make up the body 12, and share the same planform (flat shape as seen from above) as the body 12.

Printed side 14 shows that one side or the other, or in embodiments, both sides, may be printed on with an attractive pattern. Patterns possible include “Western” themes such as the traditionally elaborate curlicues and paisley patterns mixed together in shades of red, white and black, or may be other western themes such as maps, printed chasing, printed “inlay”, etc, or may be non-western themes such as occur on bandanas including colorful patterns of all types, logos, words, advertising and so on.

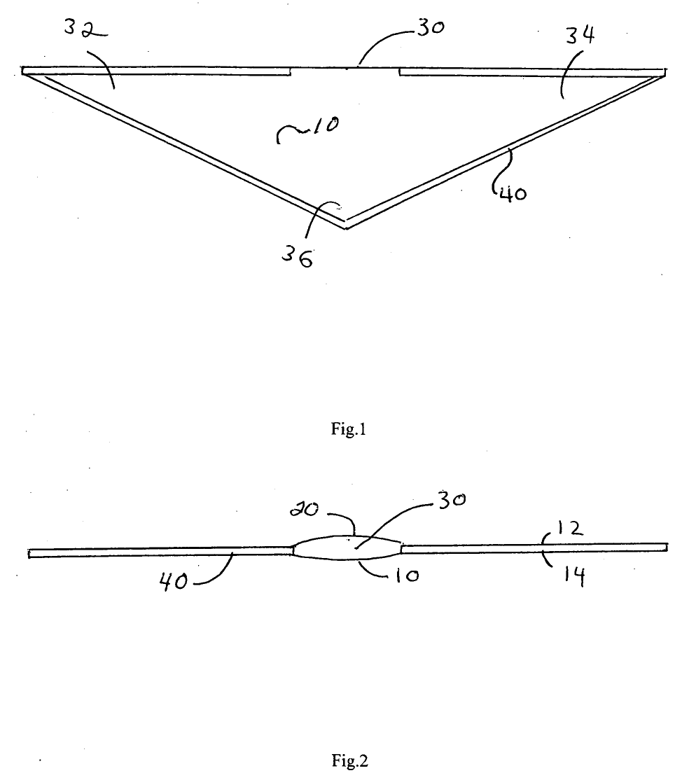

Open Portion 30 (also referred to as opening 30) is the remainder of the edge, periphery, sides or perimeter of the two layers which is not part of sealed portion (seal) 40. FIG. 2 is a front view of the first embodiment of the invention, with the opening 30 therein partially opened. Seal 40 may be a standard heat seal, or the two sides may be created by folding, extrusion, etc. The portion of the sides which is open may be thought of as the “mouth” of a bag, while the sealed sides may be the sides and bottom of the bag.

In planform, the preferred embodiment and best mode now contemplated for carrying out the invention, the invention is a right triangle. The embodiment shown is an obtuse triangle, which has other advantages. However, numerous other shapes are possible, including but not limited to generally triangular, square, prism, rectangular, pennant shaped, and may specifically include irregular shapes designed to tie more easily around the neck of a pet in “bandana” mode.

It will be seen that the triangular shape shown, having an obtuse angle 36, creates two elongated ears 32, 34. The use of the invention in “bandana” mode makes shapes having elongated areas or projections (such as 32, 34) favorable. In use, these elongated ears 32, 34 make it easy to tie these ends together around a pet neck.

Use of the device becomes fairly self-explanatory in regard to sanitary disposal of pet wastes. The user takes the device, opens open portion 30, and may additionally partially invert the interior of the bag out of open portion 30. Handling is done on the outsides of the bag. Some individuals use the inverted bag as an entire plastic glove. In either case, then opening 30 is placed over the waste to be disposed of and while continuing to handle the outside of the bag, the interior is used to handle and contain the waste, and the bag may be picked up by the outside with the pet waste sanitarily contained on the inside.

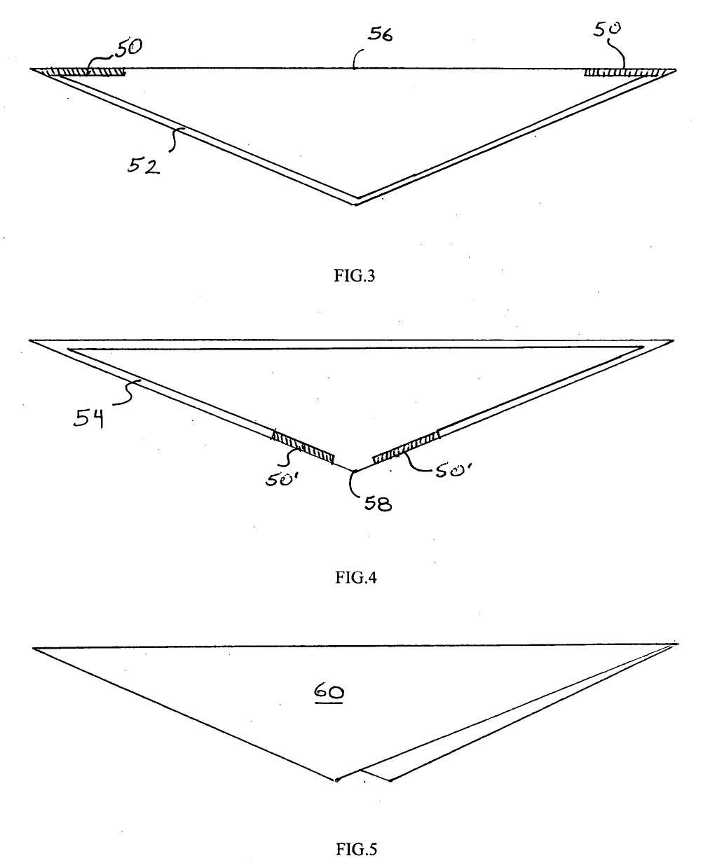

FIG. 3 is a planform top view of a second embodiment of the invention, and FIG. 4 is a planform top view a third embodiment of the invention. Stiffening Tabs 50, 50′ are located at the junction of sealed portions/seals 52, 54 and the open portions 56, 58.

Stiffening tabs 50, 50′ increase the utility of the device by increasing the ease of use in pet waste encapsulation and disposal. Stiffening tabs 50, 50′ may take the form of small slats of cardboard, wooden inserts, small wires, tabs of a stiffer form of polymer which has much less flexibility, and the like. In waste disposal usage, the pet owner may advantageously use the stiffening tabs by grasping them and using them to force other portions of the poly-bag into desired positions, such as underneath the pet waste.

The arrangement of the open and sealed portions of the invention may be varied, as is seen in FIGS. 3 and 4. In particular it may be seen that the open portion may cover all or a major portion of a side of the device as shown in FIG. 3, or it may be smaller (as shown in FIG. 1 and FIG. 2), or it may be located at a corner of the device (FIG. 4).

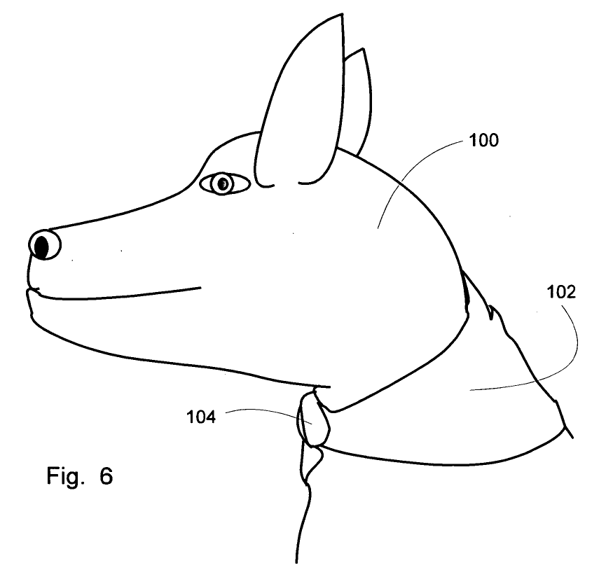

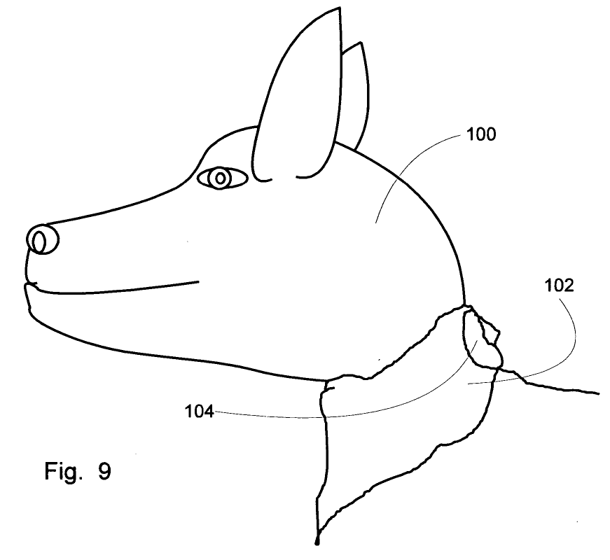

FIG. 6 is a side view of a large pet wearing the invention, while FIG. 9 is a side view of a large pet wearing the invention in a more popular fashion. Other methods of wearing may be used, as the invention is quite flexible in application. Large Pet 100 wears invention 102 tied around its neck by means of knot 104 in the elongated portions. To casual observation, the pet appears to be wearing a fashionable pet accessory. While a large pet is pictured, medium and small size pets may wear the invention as well. This may be accomplished by varying the amount of plastic material used in knot 104, or by providing alternative embodiments having different sizes for different breeds of pet. Pets for which the invention may used include dogs, wolves and mixes thereof, as well as cats of all sizes, ferrets, rodents, swine, rabbits and so on.

FIG. 5 is a perspective view of a fourth embodiment of the invention, folded for wearing by a dog. This planform of body 60 is a prism such as a diamond, but may be other types of prisms such as a parallelogram, rectangle, square and the like.

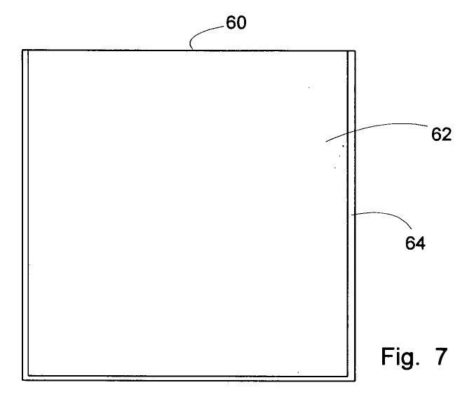

FIG. 7 is a planform top view of a fifth embodiment of the invention. Body 60 is a square planform having interior of bag 62 and sealed portion/seal 64.

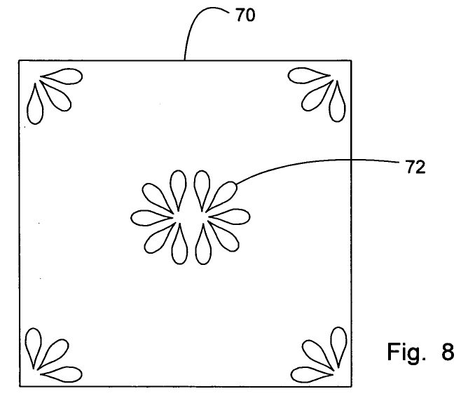

FIG. 8 is a top view of a sixth embodiment of the invention. Body 70 has printed pattern 72. As mentioned previously, this pattern may be a traditional bandana pattern, may be associated with some organization by lettering or logos, may have badges, etc. In the presently preferred embodiment and best mode presently contemplated for carrying out the invention, the bandana nature of the device is enhanced by means of printed patterns.

Printing of the pattern may occur at production. In other alternative embodiments, the design may be added by means other than printing, such as adhesion, decals, tie-dye, etc. The material of the bag may in other embodiments be inexpensive fabrics, paper, composites, and similar materials other than polymer plastics.

The disclosure is provided to allow practice of the invention by those skilled in the art without undue experimentation, including the best mode presently contemplated and the presently preferred embodiment. Nothing in this disclosure is to be taken to limit the scope of the invention, which is susceptible to numerous alterations, equivalents and substitutions without departing from the scope and spirit of the invention. The scope of the invention is to be understood from the appended claims.

1. A pet waste disposal device comprising:
a substantially flat body having a planform and edges;
the body comprising a first layer and a second layer each having a first edge portion and a second edge portion, the first and second layer having substantially the same planform as the body, the first and second layers being joined at their respective first edge portions, and forming a hole therebetween at the respective second edge portions, the first and second layer comprising a flexible polymer material;
a printed pattern on at least one of the first and second layer.

2. The pet waste disposal device of claim 1, wherein the printed pattern further comprises:
a bandana print pattern.

3. The pet waste disposal device of claim 1, wherein the planform of the first and second layers and body is a right triangle having two right edges and one hypotenuse edge and having two elongated points formed by the non-right angles of the right triangle.

4. The pet waste disposal device of claim 3, wherein the second edge portion is located on the hypotenuse edge of the right triangular body.

5. The pet waste disposal device of claim 3, wherein the second edge portion is located at one angle of the right triangular body.

6. The pet waste disposal device of claim 3, wherein the second edge portion is located at one non-hypotenuse edge of the right triangular body.

7. The pet waste disposal device of claim 1, wherein the planform of the first and second layers and body is a prism.

8. The pet waste disposal device of claim 1, further comprising:
at least one stiffener located at the first edge portion adjacent to the second edge portion.
